(19) United States
(12) Patent Application Publication
(10) Pub. No.: US 2026/0208765 A1
(43) Pub. Date: Jul. 23, 2026

(54) VEHICLE CONTROL SYSTEM

(71) Applicant: SUBARU CORPORATION, Tokyo (JP)

(72) Inventor: Fumihito YAMAGUCHI, Tokyo (JP)

(21) Appl. No.: 18/719,150

(22) PCT Filed: Jan. 18, 2023
(86) PCT No.: PCT/JP2023/001327

§ 371 Date: Jun. 12, 2024

(51) Int. Cl. B60W 60/00; B60W 50/023; G05D 1/227

(52) U.S. Cl. CPC B60W 60/0018; B60W 50/023; B60W 60/0053; G05D 1/227; B60W 2556/45

(57) ABSTRACT

A control system includes vehicles each including a travel control unit that generates a control value for travel control of a vehicle which is an own vehicle, and a server apparatus that generates respective individual remote-control values for the vehicles and transmits the respective individual remote-control values to the vehicles. Each travel control unit generates the control value using the individual remote-control value. Each travel control unit determines whether there is a malfunction in the server apparatus, and executes heteronomous travel control in which the control value is generated using the individual remote-control value when there is no malfunction in the server apparatus. Each travel control unit executes autonomous travel control in which the control value is generated using information received from an own vehicle sensor or information obtained through a manual operation when there is a malfunction in the server apparatus.

### TECHNICAL FIELD

The invention relates to a vehicle control system.

### BACKGROUND ART

It has been proposed to use a server apparatus in travel control of vehicles such as automobiles (Patent Literature 1).

### Citation List

### Patent Literature

Patent Literature 1: International Publication No. WO 2021/038741

### SUMMARY OF INVENTION

### Problem to Be Solved by the Invention

Meanwhile, when traveling of vehicles is controlled using a server apparatus as described above, an administration control system basically executes the following control.

The server apparatus acquires travel information on multiple vehicles, generates respective pieces of individual control information on the multiple vehicles based on the acquired information, and transmits the respective pieces of the individual control information to the multiple vehicles. When each of the vehicles receives the corresponding individual control information transmitted to the vehicle, the vehicle generates a control value to be actually used for the travel control of the vehicle using the individual control information, and executes the travel control based on the generated control value.

The control by the server apparatus and the control at each of the multiple vehicles are repeatedly executed. It is therefore expected that each of the vehicles makes it possible to travel with improved safety or the like under the control by the server apparatus.

However, it is difficult to deny that there is a possibility that a malfunction occurs in the server apparatus while each of the multiple vehicles is traveling under the control performed by the server apparatus.

For example, the server apparatus is generally considered to have a non-zero possibility of a program inconsistency occurring therein. For instance, there is a non-zero possibility that inconsistencies occur between programs due to program bugs, program updates, and the like in the server apparatus.

In addition, the server apparatus is to be coupled to a communication network. As a result, there is also a possibility that the server apparatus experiences unauthorized access from the outside. A possibility of the program being rewritten by hacking the server apparatus or the like is also not zero.

Even when these malfunctions occur in the server apparatus, the vehicles actually traveling on the road are to travel safely. Further, each vehicle is also to travel so as not to hinder the travel of the other vehicles.

In the vehicle control system using the server apparatus for the travel control of the vehicles, it is necessary for each vehicle traveling under the control by the server apparatus to cope with malfunctions in the server apparatus.

### Means for Solving the Problem

A vehicle control system according to an embodiment of the invention includes vehicles each including a travel control unit configured to generate a control value for travel control of a vehicle which is an own vehicle provided with the travel control unit, and a server apparatus configured to generate respective individual remote-control values for the vehicles based on travel information on the vehicles and transmits the respective individual remote-control values to the vehicles. The travel control unit of each of the vehicles is configured to generate the control value for the travel control of the own vehicle using a corresponding one of the individual remote-control value transmitted from the server apparatus to the own vehicle. The travel control unit of each of the vehicles is configured to: determine whether there is a malfunction in the server apparatus; upon not determining that there is the malfunction in the server apparatus, execute heteronomous travel control in which the control value is generated using the corresponding one of information obtained by an own vehicle sensor provided in the vehicle and the corresponding one of the individual remote-control values received from the server apparatus; and upon determining that there is the malfunction in the server apparatus, execute autonomous travel control in which the control value is generated using the information obtained by the own vehicle sensor or information obtained through a manual operation without using the corresponding one of the individual remote-control values received from the server apparatus.

### Effects of the Invention

According to the invention, the travel control unit in each of the vehicles is configured to generate the control value for the travel control of the own vehicle and determine whether there is a malfunction in the server apparatus. When it is not determined that there is the malfunction in the server apparatus, the travel control unit executes the heteronomous travel control in which the control value is generated using the information received from the own vehicle sensor and the individual remote-control value received from the server apparatus. This enables each vehicle to travel in accordance with the individual remote-control value received from the server apparatus determined to have no malfunction.

Moreover, when it is determined that there is the malfunction in the server apparatus, the travel control unit executes the autonomous travel control in which the control value is generated using the information received from the own vehicle sensor or the information obtained through a manual operation. At this time, the travel control unit generates the control value without using the individual remote-control value received from the server apparatus determined to have the malfunction. This prevents each vehicle from traveling in accordance with the individual remote-control value received from the server apparatus determined to have the malfunction.

As described above, according to the invention, each vehicle in the vehicle control system using the server apparatus to control traveling of the vehicles makes it possible to cope with a malfunction in the server apparatus.

### BRIEF DESCRIPTION OF DRAWINGS

FIG. 1 is a configuration diagram of a control system for automobiles according to one embodiment of the invention.

FIG. 2 is an explanatory diagram of a control system of the automobile illustrated in FIG. 1.

FIG. 3 is an explanatory diagram of a basic hardware configuration of a travel control apparatus of the automobile illustrated in FIG. 2.

FIG. 4 is a basic flowchart of autonomous travel control performed by the travel control apparatus of the automobile illustrated in FIG. 3.

FIG. 5 is a diagram illustrating a hardware configuration of a server apparatus illustrated in FIG. 1.

FIG. 6 is a basic timing chart of individual control of the multiple automobiles performed by the control system illustrated in FIG. 1.

FIG. 7 is a basic flowchart of control selection control performed by the travel control apparatus of the automobile illustrated in FIG. 3.

FIG. 8 is a flowchart of control performed by the travel control apparatus of the automobile illustrated in FIG. 3 to determine a malfunction in the server apparatus.

FIG. 9 is a basic flowchart of control performed by the server apparatus illustrated in FIG. 1 to transmit remote-control information.

FIG. 10 is an explanatory diagram of a method of determining a malfunction in the server apparatus performed by the travel control apparatus of the automobile.

FIG. 11 is an explanatory diagram of a method of determining a malfunction in the server apparatus performed by the travel control apparatus of the automobile.

### MODES FOR CARRYING OUT THE INVENTION

In the following, some embodiments of the invention are described with reference to the accompanying drawings.

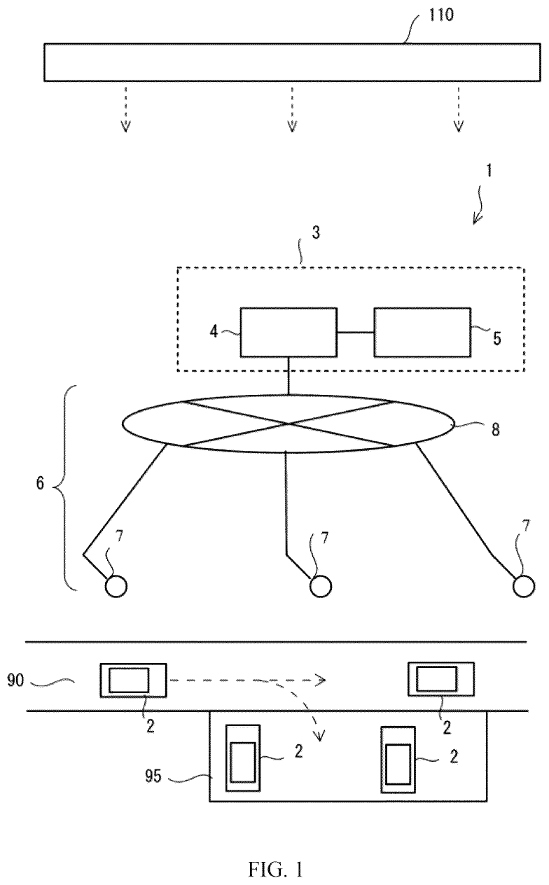

FIG. 1 is a configuration diagram of a control system 1 for automobiles 2 according to an embodiment of the invention.

The control system 1 illustrated in FIG. 1 includes the multiple automobiles 2 traveling on a road 90, and a server apparatus 3 that transmits and receives information to/from the multiple automobiles 2 via a communication system 6.

Here, the automobile 2 is an example of a vehicle. Other examples of the vehicle include a truck, a bus, a motorcycle, and a personal mobility. In FIG. 1, the multiple automobiles 2 travel on the road 90 in order. Some of the automobiles 2 are parked in a parking lot 95 facing the road 90.

The communication system 6 includes multiple base stations 7 arranged along the road 90 and a communication network 8 to which the multiple base stations 7 are coupled. The base stations 7 may be commercial 5G base stations or base stations for intelligent transportation systems such as advanced driver-assistance systems (ADAS), for example. The communication network 8 may include a carrier communication network that provides 5G base stations and the Internet coupled to the carrier communication network.

The server apparatus 3 includes a server body 4 coupled to the communication network 8 of the communication system 6, and a server DB 5 coupled to the server body 4. Basically, the server apparatus 3 may be coupled to the Internet of the communication system 6; alternatively, the server apparatus 3 may be coupled to the carrier communication network. Still alternatively, the server apparatus 3 may include multiple server bodies 4 instead of one server body 4, and the multiple server bodies 4 operates in cooperation with each other to execute distributed control. The multiple server bodies 4 may be hierarchized, for example. The multiple server bodies 4 at the lowermost layer in the hierarchy may be coupled to the carrier communication network in a distributed manner in accordance with their areas or the like. These server bodies 4 may be implemented in control apparatuses in the 5G base stations, for example.

The server apparatus 3 illustrated in FIG. 1 executes individual control of the multiple automobiles 2 present in a communication area of the communication system 6 that includes at least three zones of the base stations 7, as illustrated in FIG. 1.

In addition, a global navigation satellite system (GNSS) satellite 110 is illustrated in FIG. 1. The GNSS satellite 110 broadcasts a signal including information on its position and time to the ground. A GNSS receiver is configured to receive the signals from the multiple GNSS satellites 110 to acquire information on a position at which the GNSS receiver is present and time. The position and time of each GNSS receiver may be used as probable data which is unlikely to cause an error with respect to the position and time received at the other GNSS receivers.

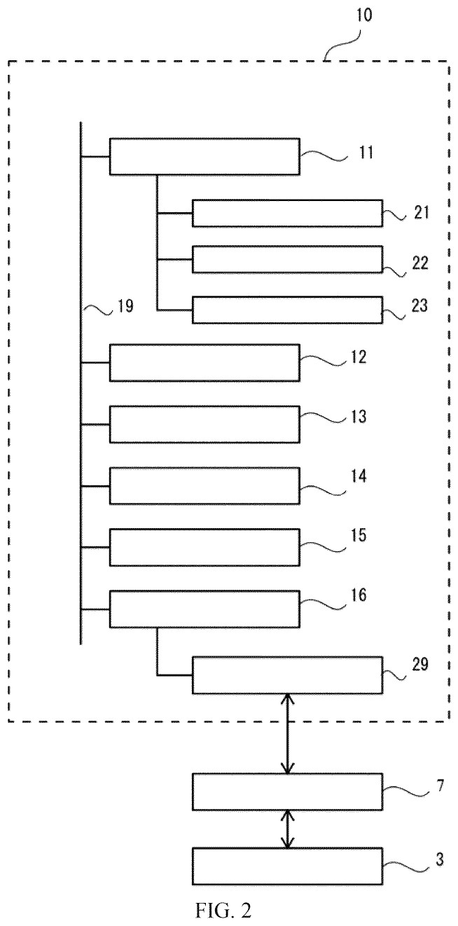

FIG. 2 is an explanatory diagram of a control system 10 of the automobile 2 illustrated in FIG. 1.

Each of the multiple automobiles 2 illustrated in FIG. 1 may include the control system 10 illustrated in FIG. 2.

The control system 10 of the automobile 2 illustrated in FIG. 2 includes a vehicle network 19 and multiple control apparatuses coupled to the vehicle network 19. In FIG. 2, a sensor control apparatus 11, a travel control apparatus 12, a drive control apparatus 13, a steering control apparatus 14, a brake control apparatus 15, and an outside-vehicle communication control apparatus 16 are illustrated as examples of the multiple control apparatuses. The control system 10 of the automobile 2 may include a control apparatus other than those described above. For example, the control system 10 of the automobile 2 may include an operation control apparatus that acquires information on a manual driving operation performed by an occupant.

The vehicle network 19 may be a network for vehicle use, such as a controller area network (CAN) or a local interconnect network (LIN). The vehicle network 19 may further include a network for general use, such as Institute of Electrical and Electronics Engineers (IEEE) 802.3 or IEEE 802.11. The use of the vehicle network 19 described above enables each of the control apparatuses to transmit and receive information to/from the other control apparatuses via the vehicle network 19.

The sensor control apparatus 11 controls operations of various own vehicle sensors provided in the automobile 2 and outputs detection information or processed information obtained by the various own vehicle sensors to the other control apparatuses via the vehicle network 19. In FIG. 2, as examples of the own vehicle sensors, a GNSS receiver 21, an outside-vehicle camera 22, and an acceleration sensor 23 are coupled to the sensor control apparatus 11. Other sensors such as a vehicle speed sensor and a steering sensor may be coupled to the sensor control apparatus 11.

The GNSS receiver 21 generates information on a position of the automobile 2 and time.

The outside-vehicle camera 22 captures an image of surroundings of the automobile 2 traveling on the road 90 or the like. The outside-vehicle camera 22 may be a monocular camera, a compound-eye camera, or a 360-degree camera. It is desirable that the outside-vehicle camera 22 be configured to capture an image of at least an environment in front of the automobile 2 while the automobile 2 is traveling. The sensor control apparatus 11 may generate information on a distance or a direction to another vehicle present around the own vehicle based on the image captured by the outside-vehicle camera 22.

The acceleration sensor 23 detects an acceleration rate of the automobile 2. As the acceleration sensor 23, a sensor that detects acceleration rates in three axial directions may be used. This enables the sensor control apparatus 11 to generate information on angular acceleration rates in yaw, pitch, and roll directions of the automobile 2.

The vehicle speed sensor detects a speed of the automobile 2.

The steering sensor detects a steering angle of a non-illustrated steering wheel of the automobile 2.

A vehicle communication device 29 provided in the automobile 2 is coupled to the outside-vehicle communication control apparatus 16. The vehicle communication device 29 establishes a wireless communication path to the base station 7 communicable with the vehicle communication device 29. The outside-vehicle communication control apparatus 16 controls an operation of the vehicle communication device 29 to transmit and receive information to/from the server apparatus 3 via the vehicle communication device 29 and the base station 7. For example, the outside-vehicle communication control apparatus 16 outputs the information transmitted from the server apparatus 3 or the base station 7 to the vehicle communication device 29 to the other control apparatuses via the vehicle network 19. The outside-vehicle communication control apparatus 16 transmits the information received from the other control apparatuses via the vehicle network 19 to the server apparatus 3 via the vehicle communication device 29 and the base station 7.

To the drive control apparatus 13, driving system members that are provided in the automobile 2 are coupled. Examples of the driving system members include an engine that generates a driving force using a fuel such as gasoline or hydrogen, a motor that generates a driving force using electric power, and a transmission. The drive control apparatus 13 controls operations of these driving system members based on control values acquired via the vehicle network 19.

To the steering control apparatus 14, a steering device provided in the automobile 2 is coupled, for example. The steering control apparatus 14 controls an operation of the steering device based on a control value acquired via the vehicle network 19.

To the brake control apparatus 15, a brake device provided in the automobile 2 is coupled. The brake control apparatus 15 controls an operation of the brake device based on a control value acquired via the vehicle network 19.

The travel control apparatus 12 controls traveling of the automobile 2. When the automobile 2 is driven by automated driving regardless of a driving operation performed by the occupant, the travel control apparatus 12 acquires information on a traveling state of the own vehicle and information on the surroundings of the own vehicle from the sensor control apparatus 11, and generates control values corresponding to these pieces of information.

When determining that another mobile body is approaching a frontal portion of the own vehicle based on the latest image captured by the outside-vehicle camera 22, for example, the travel control apparatus 12 generates a control signal that causes the brake control apparatus 15 to decelerate or stop the own vehicle.

When determining that the own vehicle in a stopped state becomes ready to start moving based on the latest image captured by the outside-vehicle camera 22, the travel control apparatus 12 generates a control value that causes the drive control apparatus 13 to accelerate the own vehicle. When determining that the own vehicle will deviate from a lane on which the own vehicle is currently traveling based on the latest image captured by the outside-vehicle camera 22, the travel control apparatus 12 generates a control value that causes the steering control apparatus 14 to change an advancing direction of the own vehicle.

When determining that the own vehicle is to turn right, turn left, or make a lane change as a result of collating the position of the GNSS receiver 21 with high-resolution map data, the travel control apparatus 12 generates a control value that causes the steering control apparatus 14 to change the advancing direction of the own vehicle.

As described above, the travel control apparatus 12 makes it possible to cause the automobile 2 to autonomously travel by performing the autonomous determination control based on the detection by the own vehicle sensor.

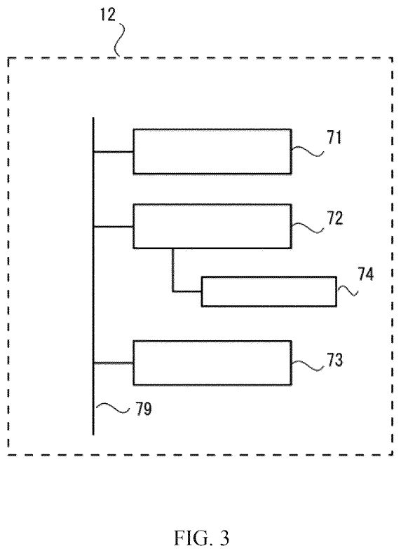

FIG. 3 is an explanatory diagram of a basic hardware configuration of the travel control apparatus 12 of the automobile 2 illustrated in FIG. 2.

The travel control apparatus 12 illustrated in FIG. 3 includes a vehicle central processing unit (CPU) 73, a vehicle memory 72, an input-output device 71 coupled to the vehicle network 19, and a vehicle internal bus 79 to which these components are coupled. Additional components such as a timer may be coupled to the vehicle internal bus 79.

The input-output device 71 receives and outputs information from/to the other control apparatuses via the vehicle network 19. This enables the travel control apparatus 12 to acquire the information necessary to the control to be performed therein.

The vehicle memory 72 stores a program, a setting value, a detection value, and the like for the travel control. FIG. 3 illustrates an example of high-resolution map data 74 stored in the vehicle memory 72. The vehicle memory 72 may be, for example, a semiconductor memory or a hard disk drive.

The vehicle CPU 73 reads the program from the vehicle memory 72 and executes the program. This implements a control unit in the travel control apparatus 12.

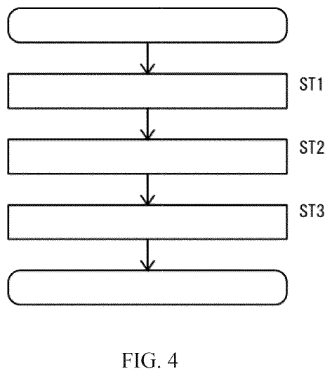

FIG. 4 is a basic flowchart of the autonomous travel control performed by the travel control apparatus 12 of the automobile 2 illustrated in FIG. 3.

The vehicle CPU 73 of the travel control apparatus 12 repeatedly executes the autonomous travel control illustrated in FIG. 4.

In Step ST1, the vehicle CPU 73 of the travel control apparatus 12 collects to acquire vehicle information such as the information on the traveling state of the own vehicle and the information on the surrounding traveling environment of the own vehicle from the sensor control apparatus 11 of the own vehicle and the like. Note that the information acquired from the sensor control apparatus 11 of the own vehicle or the like may be acquired in advance and stored in the vehicle memory 72 of the travel control apparatus 12. The vehicle information may include information on positions, directions, speeds, acceleration rates, and advancing directions of the own vehicle and the other vehicles present around the own vehicle that are included in an image captured by an in-vehicle camera, for example. The vehicle CPU 73 may generate these pieces of information by processing the information received from the sensor control apparatus 11 or the like. The vehicle information may further include information on operational states, control contents, and control results of the drive control apparatus 13, the steering control apparatus 14, the brake control apparatus 15, and the like. In addition, it is preferable that the vehicle information include the time information generated by the GNSS receiver 21.

In Step ST2, the vehicle CPU 73 of the travel control apparatus 12 generates, based on the information acquired in Step ST1, a control value that autonomously controls traveling of the own vehicle.

The vehicle CPU 73 generates the control value for the travel control of the own vehicle based on the vehicle information to reduce interference with the other automobiles or the like.

For example, the vehicle CPU 73 thereby generates a control value that accelerates the automobile 2, a control value that maintains the speed of the automobile 2, a control value that decelerates the automobile 2, a control value that stops the automobile 2, a control value that maintains the speed of the automobile 2, a steering control value that causes the automobile 2 to keep traveling in the same lane, and a steering control value that causes the automobile 2 to make a lane change, for example.

In Step ST3, the vehicle CPU 73 of the travel control apparatus 12 outputs the control value generated in Step ST2 via the vehicle network 19 to each control apparatus that executes the travel control of the own vehicle. Based on the control value, the drive control apparatus 13 executes control to cause a drive output to become the control value, the steering control apparatus 14 executes control to cause a steering angle including a steering direction to become the control value, and the brake control apparatus 15 executes control to cause a braking force to become the control value. This enables the automobile 2 to travel under the autonomous travel control performed by the travel control apparatus 12.

Thereafter, the vehicle CPU 73 of the travel control apparatus 12 terminates the control.

As described above, each of the multiple automobiles 2 is configured to to generate the control value that controls traveling of the own vehicle under the autonomous travel control performed by the travel control apparatus 12.

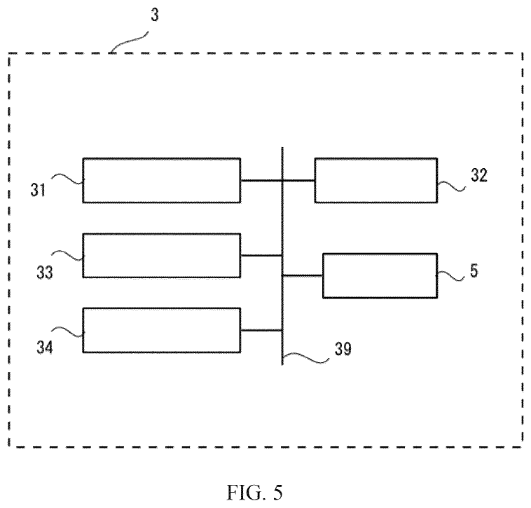

FIG. 5 is a diagram of a hardware configuration of the server apparatus 3 illustrated in FIG. 1.

The server apparatus 3 illustrated in FIG. 5 includes a server communication device 31, a server GNSS receiver 32, a server database (DB) 5, a server memory 33, a server CPU 34, and a server internal bus 39 to which these components are coupled.

The server communication device 31 is coupled to the communication network 8 of the communication system 6. The server communication device 31 transmits and receives information to/from the vehicle communication device 29 provided in the automobile 2. The server communication device 31 may receive travel information from each of the multiple automobiles 2.

The server GNSS receiver 32 generates information on a position of the server apparatus 3 and time. The time information generated by the server GNSS receiver 32 may accurately match with the time information generated by the GNSS receiver 21 of each automobile 2.

The server DB 5 accumulates various kinds of data to be used by the server apparatus 3 to individually control the multiple automobiles 2, and may store the data therein. The data may be, for example, the travel information on each automobile 2. The server DB 5 may include, for example, high-resolution map data, a road regulation database (DB), and a vehicle position behavior database (DB).

The server memory 33 stores data such as a program to be executed by the server CPU 34.

The server CPU 34 reads the program stored in the server memory 33 and executes the program. This implements a control unit that controls operations of the server apparatus 3. The control unit generates individual control information such as individual remote-control value and individual administration information that are to be used in the travel control of each automobile 2 to achieve individual travel control of each automobile 2, and transmits the generated information to each automobile 2.

Here, the individual remote-control value may be similar to the control value generated by the travel control apparatus 12 of each automobile 2, and may be directly given to the control apparatus, such as the drive control apparatus 13, that executes control in each automobile 2. The individual remote-control value is generated by the server apparatus 3 using the control value generated in the autonomous travel control described above with reference to FIG. 4, and is transmitted to each automobile 2. In this case, each automobile 2 travels under the remote control performed by the server apparatus 3.

In contrast, the individual administration information may indicate a request about the generation of the control value at the travel control apparatus 12 of each automobile 2. The individual administration information may include information on a request for acceleration or deceleration, or information on a request for a steering operation or a lane change, for example. In this case, each automobile 2 generates the control value that meets the request from the server apparatus 3 so that the automobile 2 travels under the administration control performed by the server apparatus 3.

The server CPU 34 may switch the individual control information to be generated for each automobile 2 between the individual remote-control value and the individual administration information depending on the traveling state of the automobile 2.

For example, when the automobile 2 travels straight on the road 90 as illustrated in FIG. 1, the server CPU 34 may generate the individual administration information as the individual control information on the automobile 2.

In contrast, when the automobile 2 enters the parking lot 95 from the road 90 as illustrated in FIG. 1, the server CPU 34 may generate the individual remote-control value as the individual control information on the automobile 2.

Accordingly, when the automobile 2 travels straight on the road 90 as illustrated in FIG. 1, it is possible to generate an appropriate control value that causes the automobile 2 to travel straight on the road 90 in accordance with the individual administration information and based on the detection information obtained by the own vehicle sensors of the own vehicle.

When the automobile 2 enters the parking lot 95 from the road 90 as illustrated in FIG. 1, it is possible to generate a control value based on the individual remote-control value received from the server apparatus having recognized the condition of the parking lot 95 and to cause the automobile 2 to travel toward the parking lot 95.

This enables the automobile 2 to travel safely in accordance with an instruction from the server apparatus 3 based on the information on a larger area than a detectable area of the own vehicle sensors of the own vehicle.

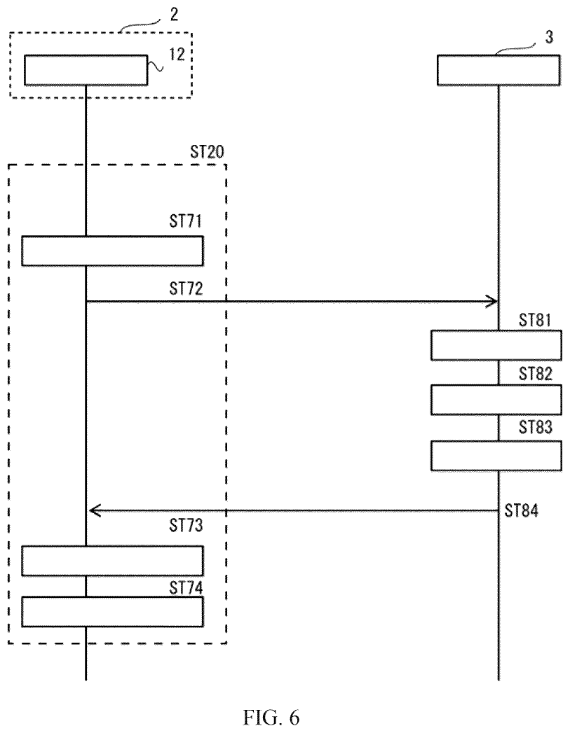

FIG. 6 is a basic timing chart of the individual control of the multiple automobiles 2 performed by the control system 1 illustrated in FIG. 1. Note that only one of the automobiles 2 is illustrated in FIG. 6 to simplify the description.

FIG. 6 illustrates an example in which each automobile 2 travels under heteronomous travel control based on the individual remote-control value generated by the server apparatus 3 (Step ST20).

In FIG. 6, time flows from an upper portion to a lower portion of the page.

During the heteronomous travel control in Step ST20, the travel control apparatus 12 of the automobile 2 first acquires the vehicle information on the own vehicle in Step ST71, and thereafter transmits the travel information on the own vehicle to the server apparatus 3 (Step ST72). The travel information on the multiple automobiles 2 are thereby collected in the server apparatus 3. Here, the travel information may basically include information necessary for the processing at the server apparatus 3. The travel information may be the vehicle information itself, or a part of the vehicle information. However, it is desirable that the travel information include at least information on a position, a speed, or the like of the automobile 2.

When receiving the travel information from the automobile 2, the server CPU 34 of the server apparatus 3 calculates the position of the automobile 2 (a vehicle S position) based on the travel information received (Step ST81). Here, the vehicle S position may be a lane of the road 90 on which the automobile 2 is traveling and a position on the lane determined using the high-resolution map data. Accordingly, the server apparatus 3 makes it possible to map each automobile 2 on the high-resolution map data. As a result, the traveling positions and the traveling states of the multiple automobiles 2 are mapped on the high-resolution map data.

Next, the server CPU 34 of the server apparatus 3 determines a possibility of future interference between the multiple automobiles 2 (Step ST82). For example, in a case where two automobiles 2 are traveling on the same lane and where the speed of one of the automobiles 2 traveling behind the other automobile 2 is higher than the speed of the other automobile 2 traveling ahead, the server CPU 34 of the server apparatus 3 determines that there is the possibility of future interference between the automobiles 2.

Thereafter, the server CPU 34 of the server apparatus 3 generates the individual control information for each of the multiple automobiles 2 (Step ST83) and transmits the individual control information to each of the automobiles 2 (Step ST84). During the execution of the remote control, the server CPU 34 generates the individual remote-control value as the individual control information. During the execution of the administration control, the server CPU 34 generates the individual administration information as the individual control information.

When receiving the individual control information from the server apparatus 3, the travel control apparatus 12 of the automobile 2 generates, based on the individual control information received from the server apparatus 3, a control value to be outputted to each control apparatus that executes the travel control of the own vehicle (Step ST73). Thereafter, the travel control apparatus 12 outputs the generated control value to the drive control apparatus 13, the steering control apparatus 14, or the brake control apparatus 15. Based on the control value, the drive control apparatus 13 executes the control to cause a drive output to become the control value, the steering control apparatus 14 executes the control to cause a steering angle including a steering direction to become the control value, and the brake control apparatus 15 executes the control to cause a braking force to become the control value.

Here, when the travel control apparatus 12 of each of the multiple automobiles 2 receives the individual remote-control value from the server apparatus 3, the individual remote-control value is usable as it is as the control value. However, the travel control apparatus 12 of the present embodiment generates the control value that reduces a change in traveling as compared with the individual remote-control value received from the server apparatus 3.

With such a series of cooperative control, the automobile 2 makes it possible to travel in accordance with the individual control information generated by the server apparatus 3 under the individual control performed by the server apparatus 3.

The server apparatus 3 make it possible to generate the individual control information such as the individual remote-control value for each of the multiple automobiles 2 based on the travel information on the multiple automobiles 2, and transmit the individual control information to the multiple automobiles 2.

Further, the travel control apparatus 12 of each of the multiple automobiles 2 makes it possible to generate the control value for the travel control of the own vehicle using the latest individual control information transmitted from the server apparatus 3 to the own vehicle.

It possible for the multiple automobiles 2 to travel safely without causing interference with each other by executing the travel control basically in accordance with the instruction from the server apparatus 3 under the individual control performed by the server apparatus 3.

Incidentally, it is difficult to deny that there is a possibility that a malfunction occurs in the server apparatus 3 while each of the multiple automobiles 2 is traveling under the control performed by the server apparatus 3.

For example, the server apparatus 3 is generally considered to have a non-zero possibility of a program inconsistency occurring therein. For instance, there is a non-zero possibility that inconsistencies occur between programs due to program bugs, program updates, and the like in the server apparatus 3.

In addition, the server apparatus 3 is to be coupled to the communication network 8 such as the Internet. As a result, there is also a possibility that the server apparatus 3 experiences unauthorized access from the outside. A possibility of the program of being rewritten by hacking the server apparatus 3 or the like is also not zero.

Even when these malfunctions occur in the server apparatus 3, each automobile 2 actually traveling on the road is to travel safely. Further, each automobile 2 is also to travel so as not to hinder the travel of the other vehicles.

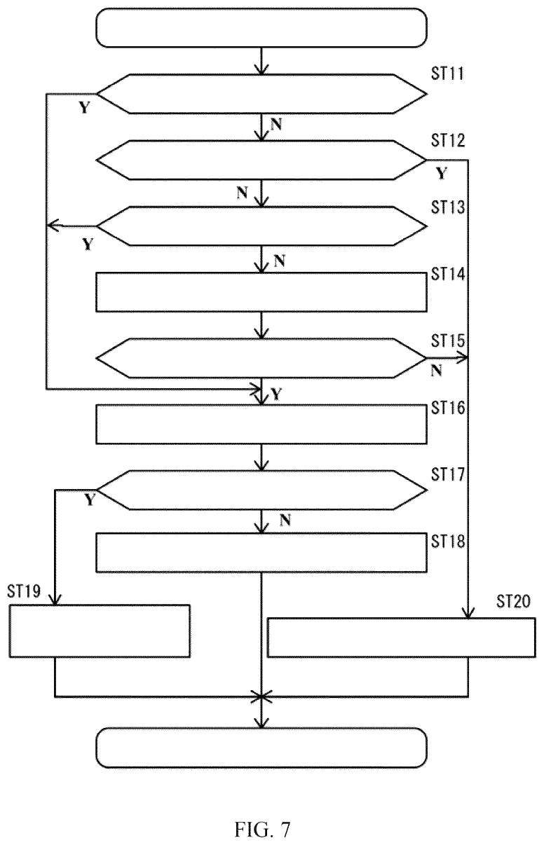

FIG. 7 is a basic flowchart of control selection control performed by the travel control apparatus 12 of the automobile 2 illustrated in FIG. 3.

The vehicle CPU 73 of the travel control apparatus 12 repeatedly executes the control selection control illustrated in FIG. 7 to dynamically switch the travel control of the own vehicle between the autonomous travel control described above with reference to FIG. 4 and the heteronomous travel control described above with reference to FIG. 6.

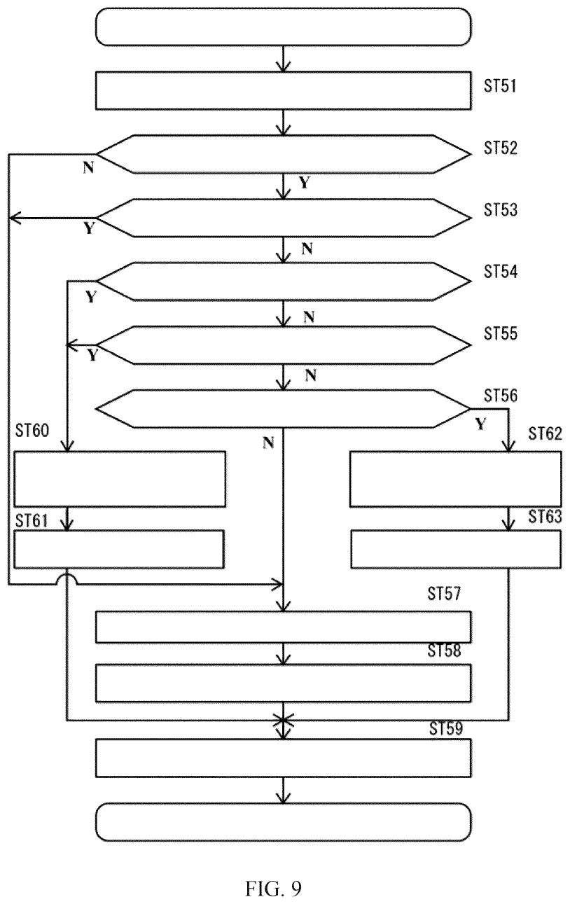

Further, as to be described later with reference to FIG. 9, when it is necessary to enforce the travel under the remote control on each automobile 2, the server apparatus 3 repeatedly transmits the remote-control information including enforcement information made significant to each automobile 2.

Further, as to be described later with reference to FIG. 9, when it is recommended to cause each automobile 2 to travel under the remote control, the server apparatus 3 repeatedly transmits the remote-control information including recommendation information made significant to each automobile 2. In the remote-control information, at most one of the enforcement information and the recommendation information may be made significant. The enforcement information is information based on which the server apparatus 3 enforces the travel in accordance with the individual remote-control value on each automobile 2. The recommendation information is information based on which the server apparatus 3 recommends each automobile 2 to travel in accordance with the individual remote-control value. Basically, the server apparatus 3 may make the enforcement information significant when a matter of urgency occurs, and may make the recommendation information significant when the automobile 2 travels in a parking lot 95.

In addition, when the server apparatus 3 determines by itself that there is a malfunction in its own control, the server apparatus 3 transmits a notification about its own malfunction to each automobile 2.

In Step S11, the vehicle CPU 73 of the travel control apparatus 12 determines whether the vehicle communication device 29 has received the notification about the malfunction from the server apparatus 3. When the vehicle communication device 29 has received the notification about the malfunction from the server apparatus 3, the vehicle CPU 73 causes the process to proceed to Step ST16 to execute the autonomous travel control. In this case, the vehicle CPU 73 causes the process to proceed to Step ST16 without determining by itself whether there is a malfunction in the server apparatus 3 in Step ST15. When the vehicle communication device 29 has not received the notification about the malfunction from the server apparatus 3, the vehicle CPU 73 causes the process to proceed to Step ST12.

In Step S12, the vehicle CPU 73 of the travel control apparatus 12 diagnoses an operation of the corresponding travel control apparatus 12, and determines by itself whether there is a malfunction in its own autonomous travel control. The vehicle CPU 73 may determine that there is a malfunction in its own autonomous travel control when periodic control values are not obtained from its own autonomous travel control that is constantly operating. In addition, the vehicle CPU 73 may determine that there is a malfunction in its own autonomous travel control when a watchdog timer which is configured to be reset in the autonomous travel control has been timed out. When it is determined that there is a malfunction in its own travel control, the vehicle CPU 73 causes the process to proceed to Step ST20 to execute the heteronomous travel control. When it is not determined that that there is a malfunction in its own travel control, the vehicle CPU 73 causes the process to proceed to Step ST13.

In Step S13, the vehicle CPU 73 of the travel control apparatus 12 determines whether a collision of the own vehicle is predicted based on an image captured by the outside-vehicle camera 22 or the like. For example, the vehicle CPU 73 may predict the possibility of a collision with another automobile or the like, based on the detection information, such as an image in the traveling direction, obtained by the own vehicle sensors. Thereafter, when the collision of the own vehicle is predicted, the vehicle CPU 73 cause the process to proceed to ST16 to execute the autonomous travel control to avoid the collision. When the collision of the own vehicle is not predicted, the vehicle CPU 73 causes the process to proceed to Step ST14.

In Step S14, the vehicle CPU 73 of the travel control apparatus 12 determines whether there is a malfunction in the server apparatus 3. Details of the determination will be described later.

In Step S15, the vehicle CPU 73 of the travel control apparatus 12 determines whether there is a malfunction in the server apparatus 3 based on the result of the determination in Step S14. When it is not determined that there is a malfunction in the server apparatus 3, the vehicle CPU 73 causes the process to proceed to step ST20 to execute the heteronomous travel control. When it is determined that there is a malfunction in the server apparatus 3, the vehicle CPU 73 causes the process to proceed to Step ST16.

In Step S16, the vehicle CPU 73 of the travel control apparatus 12 starts the autonomous travel control. First, the vehicle CPU 73 acquires the latest remote-control information having been acquired from the server apparatus 3. In the remote-control information, only one of the enforcement information and the recommendation information may be made significant, as described above.

In Step S17, the vehicle CPU 73 of the travel control apparatus 12 determines whether the enforcement information is made significant in the remote-control information acquired in Step S16. When the enforcement information is made significant, the vehicle CPU 73 causes the process to proceed to Step ST19. When the enforcement information is not made significant, the vehicle CPU 73 causes the process to proceed to Step ST18.

In Step S18, the vehicle CPU 73 of the travel control apparatus 12 executes the autonomous travel control using the detection information obtained by the own vehicle sensors to continue current traveling because the enforcement information is not made significant. Thereafter, the vehicle CPU 73 terminates the control.

As described above, in a case where the vehicle CPU 73 of the travel control apparatus 12 determines that there is a malfunction in the server apparatus 3 and where the remote-control recommendation information is made significant in the remote-control information received from the server apparatus 3, it is possible to for the own vehicle to continue to travel under the autonomous travel control.

When the vehicle CPU 73 determines that there is a malfunction in the server apparatus 3, the autonomous travel control is executed in which the control value is generated using the information detected by the own vehicle sensors of the own vehicle without using the individual remote-control value received as the individual control information from the server apparatus 3. Alternatively, the vehicle CPU 73 may generate the control value using information obtained through a manual operation by an occupant of the own vehicle.

In Step S19, the vehicle CPU 73 of the travel control apparatus 12 executes the autonomous travel control using the detection information obtained by the own vehicle sensors so that the own vehicle makes an urgency stop because the enforcement information is made significant. Thereafter, the vehicle CPU 73 terminates the control.

As described above, in a case where the vehicle CPU 73 of the travel control apparatus 12 determines that there is a malfunction in the server apparatus 3 and where the remote-control enforcement information is made significant in the remote-control information received from the server apparatus 3, it is possible to cause the own vehicle to make an urgency stop under the autonomous travel control.

When the vehicle CPU 73 determines that there is a malfunction in the server apparatus 3, the autonomous travel control is executed in which the control value is generated using the information detected by the own vehicle sensors of the own vehicle without using the individual remote-control value received as the individual control information from the server apparatus 3.

In Step S20, the vehicle CPU 73 of the travel control apparatus 12 executes the heteronomous travel control in which the control value is generated using the information detected by the own vehicle sensors of the own vehicle and the individual remote-control value received from the server apparatus 3. Thereafter, the vehicle CPU 73 terminates the control.

As described above, when it is not determined that there is a malfunction in the server apparatus 3, the vehicle CPU 73 of the travel control apparatus 12 may generate the control value using the individual remote-control value under the heteronomous travel control.

Further, when it is determined that there is a malfunction in its own autonomous travel control, the vehicle CPU 73 of the travel control apparatus 12 may generate the control value using the individual remote-control value under the heteronomous travel control even when it is not determined that there is a malfunction in the server apparatus 3.

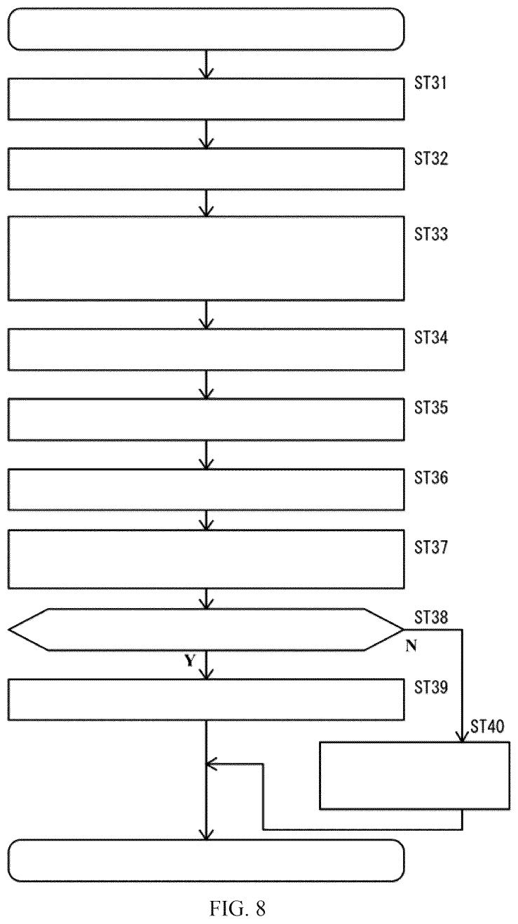

FIG. 8 is a flowchart of the control performed by the travel control apparatus 12 of the automobile 2 illustrated in FIG. 3 to determine a malfunction in the server apparatus 3.

In Step ST14 of FIG. 7, the vehicle CPU 73 of the travel control apparatus 12 executes the control to determine a malfunction in the server apparatus 3 illustrated in FIG. 8.

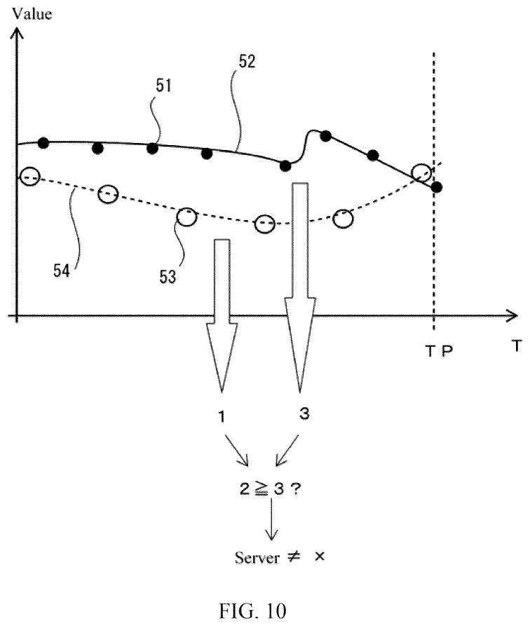

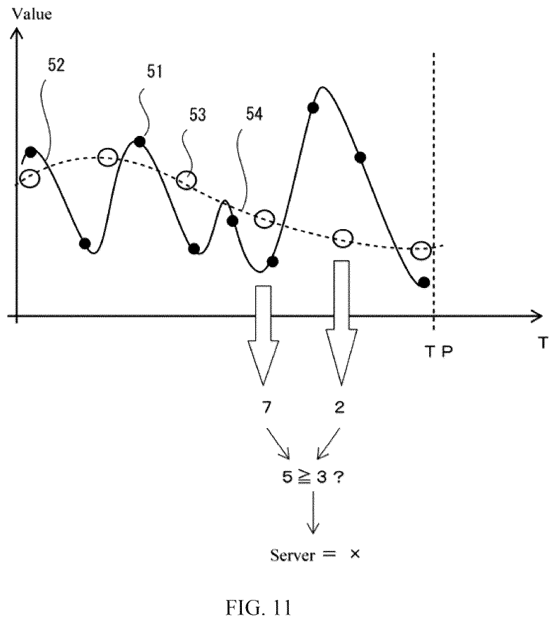

As illustrated in FIG. 10 or FIG. 11 which will be described later, in the determination control illustrated in FIG. 8, a malfunction of the server apparatus 3 is determined based on a comparison between an envelope for the multiple individual remote-control values received from the server apparatus 3 and an envelope for the multiple control values generated in the own vehicle under the autonomous travel control.

The vehicle CPU 73 may execute additional determination control other than that illustrated in FIG. 8 in Step ST14 of FIG. 7.

In Step S31, the vehicle CPU 73 of the travel control apparatus 12 plots the multiple individual remote-control values received by the vehicle communication device 29 in a predetermined time period on a graph, as illustrated in FIGS. 10 and 11 which will be described later. Each individual remote-control value may be plotted on the graph based on its value and time.

In Step S32, the vehicle CPU 73 of the travel control apparatus 12 generates the envelope for the multiple individual remote-control values and counts waveform features included in the envelope. Here, the waveform features may be, for example, the number of times of a change in the slope of the waveform in the envelope or the number of poles of the waveform included in the envelope.

In Step S33, the vehicle CPU 73 of the travel control apparatus 12 plots the multiple control values (hereinafter, referred to as autonomous control values) generated based only on the detection values obtained by the own vehicle sensors under the autonomous travel control in the predetermined time period described above, on the graph, as illustrated in FIGS. 10 and 11 which will be described later. Each autonomous control value may be plotted on the graph based on its value and time.

In Step S34, the vehicle CPU 73 of the travel control apparatus 12 generates the envelope for the multiple autonomous control values and counts waveform features included in the envelope. Here, the waveform features are the same as those used for the individual remote-control values.

In the Step S35, the vehicle CPU 73 of the travel control apparatus 12 calculates a difference between the count value of the individual remote-control values obtained in Step ST32 and the count value of the autonomous control values obtained in Step ST34.

In Step S36, the vehicle CPU 73 of the travel control apparatus 12 acquires the latest remote-control information from the server apparatus 3. In the remote-control information, only one of the enforcement information and the recommendation information may be made significant, as described above.

In Step S37, the vehicle CPU 73 of the travel control apparatus 12 reads a threshold for the information made significant in the remote-control information acquired in Step S36.

For example, when the recommendation information is made significant in the remote-control information, the vehicle CPU 73 reads a first threshold for the recommendation information.

In contrast, when the enforcement information is made significant in the remote-control information, the vehicle CPU 73 reads a second threshold for the enforcement information.

Here, the first threshold and the second threshold may be stored in the vehicle memory 72. The second threshold may be greater than the first threshold. For example, when the first threshold is 3, the second threshold may be, for example, 5 which is greater than 3. The first threshold and the second threshold may be natural numbers less than or equal to 10, for example.

In Step S38, the vehicle CPU 73 of the travel control apparatus 12 compares the difference between the count values of the waveform features calculated in Step ST35 with the threshold acquired in Step ST37.

When the difference between the count values of the waveform features is greater than or equal to the threshold, the vehicle CPU 73 causes the process to proceed to Step ST39.

In contrast, when the difference between the count values of the waveform features is less than the threshold, the vehicle CPU 73 causes the process to proceed to Step ST40.

At this time, when the vehicle CPU 73 has received the remote-control enforcement information made significant from the server apparatus 3, the second threshold is used as the threshold to be compared with the difference between the count values of the waveform features. The second threshold is greater than the first threshold that is used when the remote-control recommendation information made significant is received from the server apparatus.

In Step S39, the vehicle CPU 73 of the travel control apparatus 12 determines that there is a malfunction in the server apparatus 3 because the difference between the count values of the waveform features is greater than or equal to the threshold. Thereafter, the vehicle CPU 73 terminates the control and returns the process to FIG. 7.

In Step S40, the vehicle CPU 73 of the travel control apparatus 12 determines that there is no malfunction in the server apparatus 3 because the difference between the count values of the waveform features is less than the threshold. Thereafter, the vehicle CPU 73 terminates the control and returns the process to FIG. 7.

As described above, the vehicle CPU 73 of the travel control apparatus 12 may determine whether there is a malfunction in the server apparatus 3 by comparing the individual remote-control value received from the server apparatus 3 with the control value generated in the own vehicle under the autonomous travel control. Further, when it is determined that there is a malfunction in the server apparatus 3, the vehicle CPU 73 may further determine whether there is a malfunction in the server apparatus 3 in Step ST15 of FIG. 7 and switch the travel control of the own vehicle from the heteronomous travel control to the autonomous travel control.

FIG. 9 is a basic flowchart of control performed by the server apparatus 3 illustrated in FIG. 1 to transmit the remote-control information.

To generate the remote-control information, the server CPU 34 of the server apparatus 3 repeatedly executes the control to transmit the remote-control information illustrated in FIG. 9. In addition, the server CPU 34 switches the individual control information to be transmitted to each automobile 2 as a result of the control to transmit the remote-control information illustrated in FIG. 9 between the individual remote-control value and the individual administration information.

In Step S51, the server CPU 34 of the server apparatus 3 generates a communication reliability value of communication with the automobile 2 having received the travel information. An initial value of the communication reliability value may be 100, for example. The communication reliability value may be reduced when there is a loss or a large delay of the communication, and may be returned to the initial value when the loss or the large delay of the communication is no longer generated. In this case, the server CPU 34 assesses the communication and updates the communication reliability value every time the automobile 2 receives the travel information.

In Step S52, the server CPU 34 of the server apparatus 3 determines whether the communication reliability value updated in Step S51 is greater than or equal to a threshold. When the communication reliability value is greater than or equal to the threshold, the communication state is favorable. In this case, the server CPU 34 causes the process to proceed to Step ST53. When the communication reliability value is not greater than or equal to the threshold, the server CPU 34 causes the process to proceed to Step ST57 because the communication state may be inappropriate to continuously transmit the individual remote-control value.

In Step S53, the server CPU 34 of the server apparatus 3 determines whether a notification about the server malfunction determination has been received from the automobile 2. After it is determined that there is a malfunction in the server apparatus 3 in Step ST15 of FIG. 7, for example, the travel control apparatus 12 of the automobile 2 transmits the information indicating that it has been determined that there is a malfunction in the server apparatus 3 to the server apparatus 3 in addition to the travel information in Step ST72 of FIG. 6. The server CPU 34 may determine whether the notification about the server malfunction determination has been received based on whether such additional information is included in the travel information. When the notification about the server malfunction determination has not been received, the server CPU 34 causes the process to proceed to Step ST54. When the notification about the server malfunction determination has been received, the server CPU 34 causes the process to proceed to Step ST57 to generate the individual administration information rather than the individual remote-control value.

In Step S54, the server CPU 34 of the server apparatus 3 determines whether there is a malfunction in the automobile 2. When a malfunction occurs in the own vehicle, the travel control apparatus 12 of the automobile 2 transmits the travel information including the information on the malfunction. The server CPU 34 may determine whether there is a malfunction in the automobile 2 based on whether such information on the malfunction is included in the travel information. When there is a malfunction in the automobile 2, the server CPU 34 causes the process to proceed to Step ST60 to suppress the execution of the autonomous travel control of the automobile 2. When there is no malfunction in the automobile 2, the server CPU 34 causes the process to proceed to Step ST55.

In Step S55, the server CPU 34 of the server apparatus 3 determines whether the remote control is to be enforced in the individual control of the automobile 2. The server CPU 34 may determine that the remote control is to be enforced when the automobile 2 needs to allow an emergency vehicle to pass by, for example. When the remote control is to be enforced, the server CPU 34 causes the process to proceed to Step ST60 to suppress the execution of the autonomous travel control of the automobile 2. When the remote control is not to be enforced, the server CPU 34 causes the process to proceed to Step ST56.

In Step S56, the server CPU 34 of the server apparatus 3 determines whether the remote control is to be recommended in the individual control of the automobile 2. The server CPU 34 may determine that the remote control is to be recommended when the automobile 2 will be parked and stopped in the parking lot 95, for example. When the remote control is to be recommended, the server CPU 34 causes the process to proceed to Step ST62 to suppress the execution of the autonomous travel control of the automobile 2. When the remote control is not to be recommended, the server CPU 34 causes the process to proceed to Step ST57 to cause the automobile 2 to execute the heteronomous travel control in accordance with the individual administration information.

In Step S57, neither the enforcement information nor the recommendation information to be included in the remote-control information is made significant by the server CPU 34 of the server apparatus 3. The remote-control information includes no information made significant.

In Step S58, the server CPU 34 of the server apparatus 3 generates the individual administration information.

In Step S59, the server CPU 34 of the server apparatus 3 transmits the information generated for the individual control to the corresponding automobile 2. While Step S58 is being executed, the server CPU 34 transmits the individual administration information and the remote-control information including no information made significant. Thereafter, the server CPU 34 terminates the control.

In Step S60, the server CPU 34 of the server apparatus 3 makes the enforcement information to be included in the remote-control information significant and does not make the recommendation information significant. The remote-control information includes the enforcement information made significant.

In Step S61, the server CPU 34 of the server apparatus 3 generates the individual remote-control value. In this case, the server CPU 34 transmits the individual remote-control value together with the remote-control information including the enforcement information made significant in Step S59. Thereafter, the server CPU 34 terminates the control.

In Step S62, the server CPU 34 of the server apparatus 3 makes the recommendation information to be included in the remote-control information significant and does not make the enforcement information significant. The remote-control information includes the recommendation information made significant.

In Step S63, the server CPU 34 of the server apparatus 3 generates the individual remote-control value. In this case, the server CPU 34 transmits the individual remote-control value together with the remote-control information including the recommendation information made significant in Step S59. Thereafter, the server CPU 34 terminates the control.

As described above, the server apparatus 3 determines whether each of the multiple automobiles 2 is to cope with a matter of urgency. When determining that the automobile 2 is to cope with the matter of urgency, the server apparatus 3 may transmit the remote-control information including the remote-control enforcement information made significant, in addition to the individual remote-control value.

Further, when receiving the determination result indicating that there is a malfunction in the server apparatus 3 from a malfunction determination automobile that has determined that there is a malfunction in the server apparatus 3, the server apparatus 3 may switch the information for the travel control to be transmitted to the malfunction determination automobile from the individual remote-control value usable as it is for the travel control of the malfunction determination automobile to the individual administration information including the request for the travel control of the automobile 2.

Described next is a specific example of the server malfunction determination performed by the travel control apparatus 12 of the automobile 2.

FIGS. 10 and 11 are explanatory diagrams of the method of determining a malfunction in the server apparatus 3 performed by the travel control apparatus 12 of the automobile 2.

FIG. 10 illustrates an example of a case where it is not determined that there is a malfunction in the server apparatus 3. In contrast, FIG. 11 illustrates an example of a case where it is determined that there is a malfunction in the server apparatus 3.

In each graph illustrated in these drawings, a horizontal axis represents time, and a vertical axis represents a value.

The multiple individual remote-control values transmitted from the server apparatus 3 to the respective automobiles 2 are each denoted by a reference numeral 51. An envelope for the individual remote-control values based on the multiple individual remote-control values 51 is denoted by a reference numeral 52.

The multiple autonomous control values generated by the autonomous travel control based on the detection by the own vehicle sensors are each denoted by a reference numeral 53. The travel control apparatus 12 may repeatedly execute the autonomous travel control illustrated in, for example, FIG. 4 at all times, and may repeatedly generate a control value to be actually used for the control, and the autonomous control values based on the detection by the own vehicle sensors. An envelope for the autonomous control values based on the multiple autonomous control values is denoted by a reference numeral 52.

In the example illustrated in FIG. 10 where it is not determined that there is a malfunction in the server apparatus 3, the envelope 52 based on the multiple individual remote-control values 51 has a waveform having three poles.

In contrast, the envelope 54 based on the multiple autonomous control values 53 has a waveform having one pole.

In this case, in Step ST35 of FIG. 8, the travel control apparatus 12 calculates the difference in the number of waveform features as “2(=3−1)”. When the threshold acquired in Step ST37 is 3, for example, the travel control apparatus 12 determines that the difference in the number of waveform features is smaller than the threshold in Step ST38, and causes the process to proceed to Step ST40.

Thereafter, the travel control apparatus 12 determines that there is no malfunction in the server apparatus 3 in Step ST15 of FIG. 7, and executes the heteronomous travel control in Step ST20.

In contrast, in the example of FIG. 11 where it is determined that there is a malfunction in the server apparatus 3, the envelope 52 based on the multiple individual remote-control values 51 has a waveform having seven poles.

In contrast, the envelope 54 for the multiple autonomous control values 53 has a waveform having two poles.

In this case, in Step ST35 of FIG. 8, the travel control apparatus 12 calculates the difference in the number of waveform features as “5(=7−2)”. When the threshold acquired in Step ST37 is 3, for example, the travel control apparatus 12 determines that the difference in the number of waveform features is greater than or equal to the threshold in Step ST38, and causes the process to proceed to Step ST39.

Thereafter, the travel control apparatus 12 determines that there is a malfunction in the server apparatus 3 in Step ST15 of FIG. 7, and executes the autonomous travel control in Step ST18 or Step ST19.

As described above, in each of the multiple automobiles 2 of the present embodiment, the travel control apparatus 12 configured to generate the control value for the travel control of the own vehicle determines whether there is a malfunction in the server apparatus 3. When it is not determined that there is a malfunction in the server apparatus 3, the travel control apparatus 12 executes the heteronomous travel control in which the control value is generated using the information on the own vehicle received from the own vehicle sensor and the individual remote-control value received from the server apparatus 3. This enables each automobile 2 to travel in accordance with the individual remote-control value received from the server apparatus 3 that has not been determined to have a malfunction.

Moreover, when it is determined that there is a malfunction in the server apparatus 3, the travel control apparatus 12 executes the autonomous travel control in which the control value is generated using the information on the own vehicle received from the own vehicle sensor or the information obtained through a manual operation. At this time, the travel control apparatus 12 generates the control value without using the individual remote-control value received from the server apparatus 3 determined to have the malfunction. This prevents each automobile 2 from traveling in accordance with the individual remote-control value received from the server apparatus 3 determined to have the malfunction.

As described above, in the present embodiment, each automobile 2 in the control system 1 for the automobiles 2 that includes the server apparatus 3 to control traveling of the automobiles 2 makes it possible to cope with a malfunction in the server apparatus 3, if any.

The above-described embodiments are examples of preferred embodiments of the invention; however, the invention is not limited thereto, and various modifications or changes may be made without departing from the gist of the invention.

### Description of Reference Numerals

1 Vehicle control system
2 Automobile (Vehicle)
3 Server apparatus
4 Server body
5 Server DB
6 Communication system
7 Base station
8 Communication network
10 Control system
11 Sensor control apparatus
12 Travel control apparatus
13 Drive control apparatus
14 Steering control apparatus
15 Brake control apparatus
16 Outside-vehicle communication control apparatus
19 Vehicle network
21 GNSS receiver
22 Outside-vehicle camera
23 Acceleration sensor
29 Vehicle communication device
31 Server communication device
32 Server GNSS receiver
33 Server memory
34 Server CPU
39 Sever internal bus
51 Individual remote-control value
52 Envelope based on multiple individual remote-control values
53 Autonomous control value
54 Envelope based on multiple autonomous control values
71 Input-output device
72 Vehicle memory
73 Vehicle CPU
74 High-resolution map data
79 Vehicle internal bus
90 Road
95 Parking lot
110 GNSS satellite

1. A vehicle control system comprising:
vehicles each comprising a travel control unit configured to generate a control value for travel control of a vehicle which is an own vehicle provided with the travel control unit; and
a server apparatus configured to generate respective individual remote-control values for the vehicles based on travel information on the vehicles and transmit the respective individual remote-control values to the vehicles, wherein
the travel control unit of each of the vehicles is configured to generate the control value for the travel control of the own vehicle using a corresponding one of the individual remote-control values transmitted from the server apparatus to the own vehicle,
the travel control unit of each of the vehicles is configured to
determine whether there is a malfunction in the server apparatus,
upon not determining that there is the malfunction in the server apparatus, execute heteronomous travel control in which the control value is generated using information obtained by an own vehicle sensor provided in the own vehicle and the corresponding one of the individual remote-control values received from the server apparatus, and
upon determining that there is the malfunction in the server apparatus, execute autonomous travel control in which the control value is generated using the information obtained by the own vehicle sensor or information obtained through a manual operation without using the corresponding one of the individual remote-control values received from the server apparatus.

2. The vehicle control system according to claim 1, wherein the travel control unit of each of the vehicles is configured to determine whether there is the malfunction in the server apparatus by comparing the individual remote-control value received from the server apparatus with the control value generated in the own vehicle under the autonomous travel control.

3. The vehicle control system according to claim 2, wherein
the travel control unit of each of the vehicles is configured to
compare an envelope for corresponding individual remote-control values comprising the corresponding one of individual remote-control values received from the server apparatus with an envelope for control values comprising the control value generated in the own vehicle under the autonomous travel control,
determine whether a difference in a number of waveform features included in the envelopes compared with each other is greater than or equal to a threshold, and
determines that there is the malfunction in the server apparatus when the difference is greater than or equal to the threshold.

4. The vehicle control system according to claim 1, wherein the travel control unit of each of the vehicles is configured to generate the control value that reduces a change in traveling in the heteronomous travel control in which the control value is generated using the individual remote-control value received from the server apparatus, as compared with a case where the individual remote-control value received from the server apparatus is used as it is as the control value.

5. The vehicle control system according to claim 4, wherein the travel control unit of each of the vehicles is configured to execute the autonomous travel control when receiving a notification about the malfunction from the server apparatus.

6. The vehicle control system according to claim 5, wherein
the server apparatus is configured to determine whether each of the vehicles is to cope with a matter of urgency, and transmit remote-control information in which one of remote-control enforcement information and remote-control recommendation information is enabled to be made significant in addition to the individual remote-control value to a vehicle among the vehicle that is determined to cope with the matter of urgency, and
the travel control unit of each of the vehicles is configured to
upon determining that there is the malfunction in the server apparatus when the remote-control enforcement information is made significant in the remote-control information received from the server apparatus, cause the own vehicle to make an urgency stop under the autonomous travel control, and
upon determining that there is the malfunction in the server apparatus in a case where the remote-control recommendation information is made significant in the remote-control information received from the server apparatus, cause the own vehicle to continue to travel under the autonomous travel control.

7. The vehicle control system according to claim 6, wherein the travel control unit of each of the vehicles is configured to, when the remote-control enforcement information made significant is received from the server apparatus, use, a second threshold as the threshold to be compared with the difference the second threshold being greater than a first threshold to be used when the remote-control recommendation information made significant is received from the server apparatus.

8. The vehicle control system according to claim 7, wherein the travel control unit of each of the vehicles is configured to
determine whether there is a malfunction in the autonomous travel control performed by the travel control unit itself, and
upon determining that there is the malfunction in the autonomous travel control performed by the travel control unit itself, generate the control value using the individual remote-control value under the heteronomous travel control.

9. The vehicle control system according to claim 8, wherein, the server apparatus is configured to, when receiving a determination result indicating that that there is the malfunction in the server apparatus from a malfunction determination vehicle having determined that there is the malfunction in the server apparatus, switch information for travel control to be transmitted to the malfunction determination vehicle from the individual remote-control value usable as it is for the travel control of the malfunction determination vehicle to individual administration information comprising a request for the travel control of the vehicle.

10. A vehicle comprising:
a vehicle communication device configured to communicate with a server apparatus, the server apparatus being configured to generate individual remote-control values for vehicles respectively based on travel information on the vehicles and transmit the individual remote-control values to the vehicles respectively;
an own vehicle sensor provided in the vehicle; and
a travel control unit configured to generate a control value for travel control of the vehicle which is an own vehicle using a corresponding one of the individual remote-control values transmitted from the server apparatus to the own vehicle and received by the vehicle communication device, wherein
the travel control unit is configured to
determine whether there is a malfunction in the server apparatus, upon not determining that there is the malfunction in the server apparatus, execute heteronomous travel control in which the control value is generated using information obtained by the own vehicle sensor and the corresponding one of the individual remote-control values received from the server apparatus, and
upon determining that there is the malfunction in the server apparatus, execute autonomous travel control in which the control value is generated using the information obtained by the own vehicle sensor or information obtained through a manual operation without using the corresponding one of the individual remote-control values received from the server apparatus.

11. A server apparatus comprising:
a server communication device configured to communicate with vehicles each comprising a travel control unit configured to generate a control value for travel control of a vehicle; and
a server control unit configured to generate individual remote-control values for the vehicles respectively based on travel information on the vehicles received by the server communication device and transmit the individual remote-control values from the server communication device to the vehicles respectively, wherein
the server control unit is configured to, when receiving a determination result indicating that there is a malfunction in the server apparatus from a malfunction determination vehicle out of the vehicles to which the individual remote control values are to be transmitted respectively, switch information for travel control to be transmitted to the malfunction determination vehicle from a corresponding one of the individual remote-control values usable as it is for the travel control of the malfunction determination vehicle to individual administration information comprising a request for the travel control of the vehicle.

12. The vehicle control system according to claim 2, wherein the travel control unit of each of the vehicles is configured to generate the control value that reduces a change in traveling in the heteronomous travel control in which the control value is generated using the individual remote-control value received from the server apparatus, as compared with a case where the individual remote-control value received from the server apparatus is used as it is as the control value.

13. The vehicle control system according to claim 3, wherein the travel control unit of each of the vehicles is configured to generate the control value that reduces a change in traveling in the heteronomous travel control in which the control value is generated using the individual remote-control value received from the server apparatus, as compared with a case where the individual remote-control value received from the server apparatus is used as it is as the control value.

14. The vehicle control system according to claim 12, wherein the travel control unit of each of the vehicles is configured to execute the autonomous travel control when receiving a notification about the malfunction from the server apparatus.

15. The vehicle control system according to claim 13, wherein the travel control unit of each of the vehicles is configured to execute the autonomous travel control when receiving a notification about the malfunction from the server apparatus.

16. The vehicle control system according to claim 14, wherein
the server apparatus is configured to determine whether each of the vehicles is to cope with a matter of urgency, and transmit remote-control information in which one of remote-control enforcement information and remote-control recommendation information is enabled to be made significant in addition to the individual remote-control value to a vehicle among the vehicle that is determined to cope with the matter of urgency, and
the travel control unit of each of the vehicles is configured to
upon determining that there is the malfunction in the server apparatus when the remote-control enforcement information is made significant in the remote-control information received from the server apparatus, cause the own vehicle to make an urgency stop under the autonomous travel control, and
upon determining that there is the malfunction in the server apparatus in a case where the remote-control recommendation information is made significant in the remote-control information received from the server apparatus, cause the own vehicle to continue to travel under the autonomous travel control.

17. The vehicle control system according to claim 15, wherein
the server apparatus is configured to determine whether each of the vehicles is to cope with a matter of urgency, and transmit remote-control information in which one of remote-control enforcement information and remote-control recommendation information is enabled to be made significant in addition to the individual remote-control value to a vehicle among the vehicle that is determined to cope with the matter of urgency, and
the travel control unit of each of the vehicles is configured to
upon determining that there is the malfunction in the server apparatus when the remote-control enforcement information is made significant in the remote-control information received from the server apparatus, cause the own vehicle to make an urgency stop under the autonomous travel control, and
upon determining that there is the malfunction in the server apparatus in a case where the remote-control recommendation information is made significant in the remote-control information received from the server apparatus, cause the own vehicle to continue to travel under the autonomous travel control.
